(19) United States
(12) Patent Application Publication
(10) Pub. No.: US 2018/0165234 A1
(43) Pub. Date: Jun. 14, 2018

(54) MULTI MEDIA DATA STORING AND TRANSMITTING APPARATUS

(71) Applicant: Oxti Corporation, Taipei (TW)

(72) Inventor: Chih Feng HO, Taipei (TW)

(21) Appl. No.: 15/373,503

(22) Filed: Dec. 9, 2016

(51) Int. Cl. G06F 13/38; G06F 13/42; G06F 1/26; G06F 13/40

(52) U.S. Cl. CPC G06F 13/385; G06F 13/4077; G06F 1/266; G06F 13/4282

(57) ABSTRACT

An multi media data storing and transmitting apparatus includes a control module engaged in a receptacle, the control module includes a voltage output regulating module and a data telecommunicating module, an information storing module connected to the data telecommunicating module, a battery module connected to the control module, a charging module connected to the battery module, an electric coupler connected to the charging module, a wireless charging module connected to the control module, and an antenna element connected to the wireless charging module and the data telecommunicating module for communicating with an electrical appliance and for charging the electrical appliance.

### BACKGROUND OF THE INVENTION

### 1. Field of the Invention

The present invention relates to a multi media data storing and transmitting apparatus, and more particularly to a multi media data storing and transmitting apparatus for telecommunicating with various electrical appliances, such as portable electrical appliances including notebooks, tablets, mobile phones, portable phones, etc., and for charging the electrical appliances wirelessly or remotely.

### 2. Description of the Prior Art

Various kinds of typical multi media data storing and transmitting apparatuses have been developed and arranged for receiving and/or transmitting signals from and between portable electrical appliances, such as notebooks, tablets, mobile phones, portable phones, etc. For example, the typical multi media data storing and transmitting apparatuses may include a coupler, such as a universal serial bus (USB) for connecting or coupling to various kinds of electrical appliances for data receiving and/or transmitting purposes.

Some of the typical multi media data storing and transmitting apparatuses may include the other transmitting apparatuses, such as Bluetooth, or Wireless Fidelity (wifi) etc. for data receiving and/or transmitting purposes wirelessly or remotely. However, the Bluetooth apparatus may not be provided for suitably transmitting a large amount of image and word data; and the wifi apparatus should be processed through a wireless sharing appliance, and the wifi apparatus may not be used or worked without the wireless sharing appliance.

For example, U.S. Pat. No. 5,500,672 to Fujii, U.S. Pat. No. 6,175,573 to Togo et al., U.S. Pat. No. 6,839,736 to Kajita et al., U.S. Pat. No. 7,596,598 to Birch, U.S. Pat. No. 8,059,575 to Wang et al., and U.S. Pat. No. 9,462,311 to Hwang et al. disclose several of the typical multi media data storing and transmitting apparatuses capable of receiving and/or transmitting data or information wirelessly or remotely.

However, the typical multi media data storing and transmitting apparatuses may not be used for charging the portable electrical appliances wirelessly or remotely.

The present invention has arisen to mitigate and/or obviate the afore-described disadvantages of the conventional multi media data storing and transmitting apparatuses.

### SUMMARY OF THE INVENTION

The primary objective of the present invention is to provide a multi media data storing and transmitting apparatus for telecommunicating with various electrical appliances, such as portable electrical appliances including notebooks, tablets, mobile phones, portable phones, etc., and for charging the electrical appliances wirelessly or remotely.

In accordance with one aspect of the invention, there is provided a multi media data storing and transmitting apparatus comprising an electrical appliance, a receptacle, and a control module engaged in the receptacle, the control module including a voltage output regulating module and a data telecommunicating module, an information storing module engaged in the receptacle and electrically connected to the data telecommunicating module of the control module, a battery module engaged in the receptacle and electrically connected to the control module, a first charging module engaged in the receptacle and electrically connected to the battery module, a first electric coupler electrically connected to the first charging module, a wireless charging module engaged in the receptacle and electrically connected to the control module, and an antenna element electrically connected to the wireless charging module and electrically connected to the data telecommunicating module of the control module for telecommunicating with the electrical appliance.

The information storing module is selected from a compact disc. A second charging module is engaged in the receptacle and electrically connected to the voltage output regulating module of the control module, and a second electric coupler is electrically connected to the second charging module and electrically connected to the data telecommunicating module of the control module for telecommunicating with the electrical appliance.

The control module includes a capacity detecting module electrically connected to the battery module. A displayer is electrically connected to the control module for displaying a data or information or the like.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating the operation of a multi media data storing and transmitting apparatus in accordance with the present invention with a notebook wirelessly or remotely;

FIG. 2 is another partial exploded view similar to FIG. 1, illustrating the operation of the multi media data storing and transmitting apparatus with a tablet wirelessly or remotely;

FIG. 3 is a further partial exploded view similar to FIGS. 1 and 2, illustrating the operation of the multi media data storing and transmitting apparatus with a portable phone wirelessly or remotely;

FIG. 4 is a block diagram of the multi media data storing and transmitting apparatus;

FIG. 5 is another block diagram similar to FIG. 4, illustrating the operation of the multi media data storing and transmitting apparatus;

FIG. 6 is a further block diagram similar to FIGS. 4 and 5, illustrating the operation of the multi media data storing and transmitting apparatus;

FIG. 7 is a still further block diagram similar to FIGS. 4-6, illustrating the operation of the multi media data storing and transmitting apparatus;

FIG. 8 is a perspective view illustrating the operation of the multi media data storing and transmitting apparatus with a wire; and

FIGS. 9, 10 are block diagrams illustrating the operation of the multi media data storing and transmitting apparatus as shown in FIG. 8.

### DETAILED DESCRIPTION OF THE PREFERRED EMBODIMENT

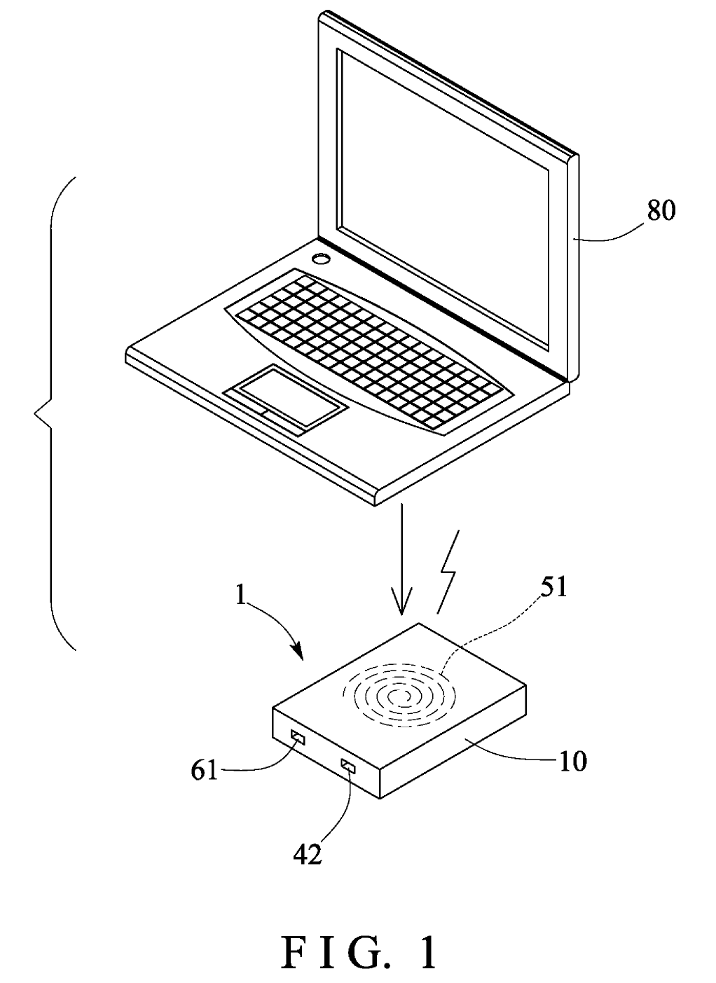

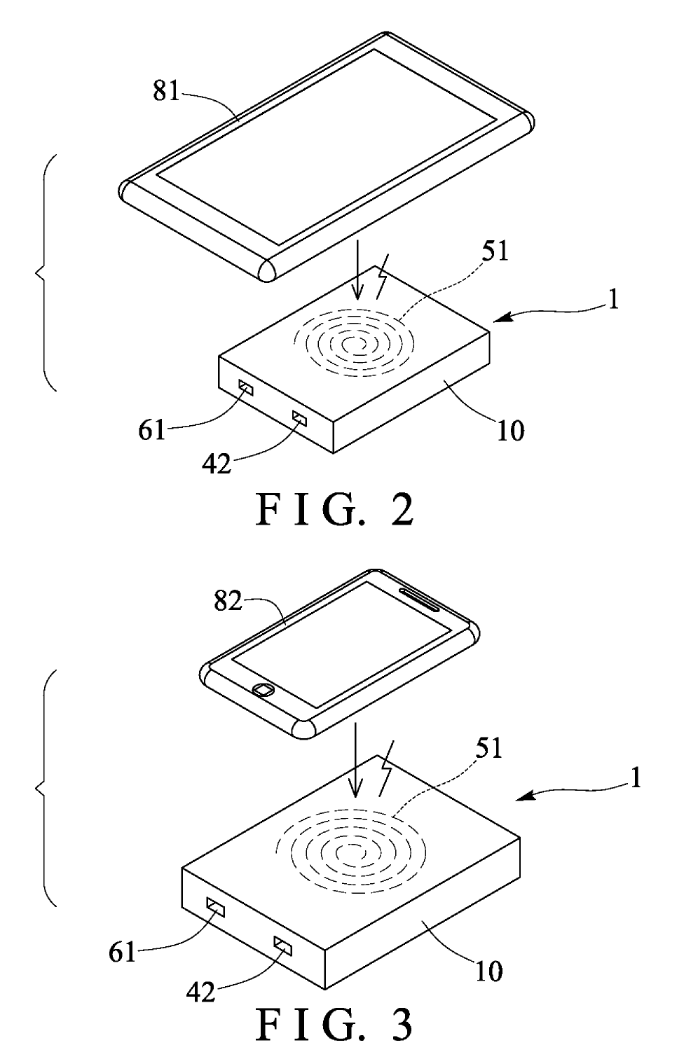

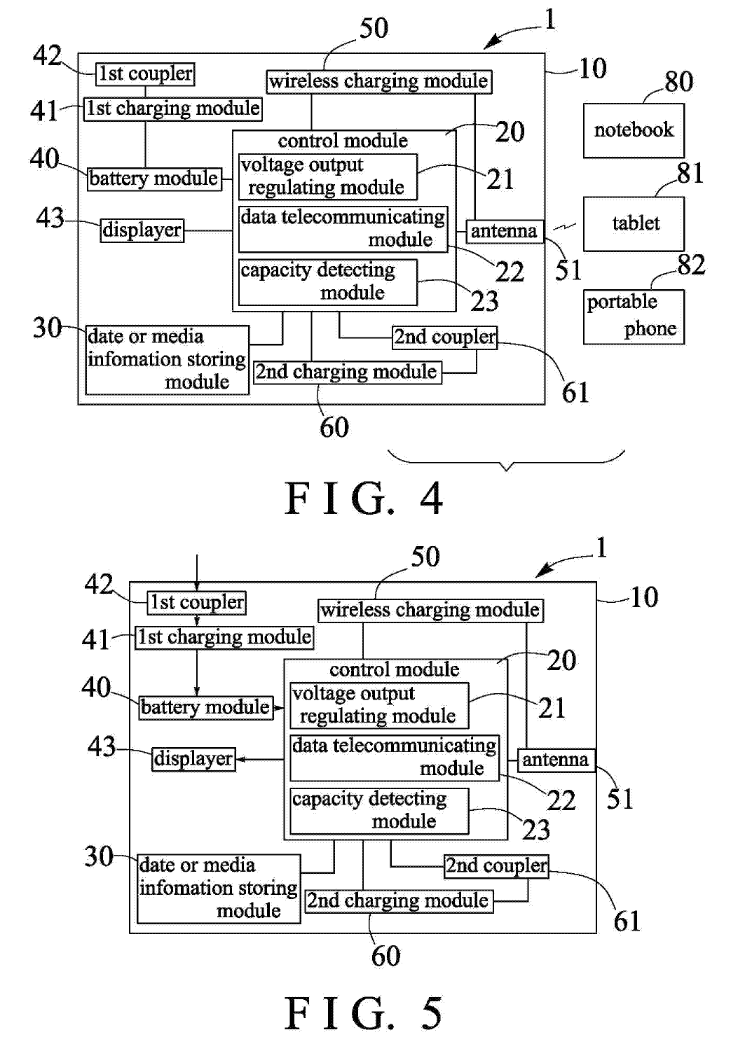

Referring to the drawings, and initially to FIGS. 1-4, a multi media data storing and transmitting apparatus 1 in accordance with the present invention is provided for telecommunicating with various electrical appliances, such as portable electrical appliances, selected from notebooks 80 (FIG. 1), tablets 81 (FIG. 2), mobile phones or portable phones 82 (FIG. 3), or the like, and the multi media data storing and transmitting apparatus 1 includes an outer housing or receptacle 10, a control module 20 disposed and received or engaged in the receptacle 10, and the control module 20 includes a voltage output regulating module 21, a data telecommunicating or transmitting module 22, and a capacity sensing or detecting module 23. The voltage output regulating module 21 and/or the data telecommunicating module 22 and/or the capacity detecting module 23 may be electrically connecting or coupling together and/or communicating with each other.

A data or media information storing module 30 may also be disposed and received or engaged in the receptacle 10 and electrically connected or coupled to the control module 20, such as connected to the data telecommunicating module 22 of the control module 20, the information storing module 30 may be selected from a compact disc or the like for data or information storing purposes. A battery module 40 is electrically connected or coupled to the control module 20, such as connected to the capacity detecting module 23 for providing an electric power supply to the control module 20, a first charging module 41 is electrically connected or coupled to the battery module 40, and a first electric connection port or terminal or coupler 42, such as a universal serial bus (USB) is electrically connected or coupled to the first charging module 41 for connecting or coupling to an electric power supply or reservoir (not illustrated) or the like.

The battery module 40 and the first charging module 41 are also disposed and received or engaged in the receptacle 10. A displayer 43 is electrically connected or coupled to the control module 20 for showing or displaying various data or information or the like. A remote or wireless charging module 50 is also disposed and received or engaged in the receptacle 10 and electrically connected or coupled to the control module 20, such as connected to the voltage output regulating module 21 of the control module 20, for wireless telecommunicating and/or charging purposes, and an antenna module or element 51 is also disposed and received or engaged in the receptacle 10 and electrically connected or coupled to the wireless charging module 50, and also electrically connected or coupled to the control module 20, such as connected to the data telecommunicating module 22 of the control module 20.

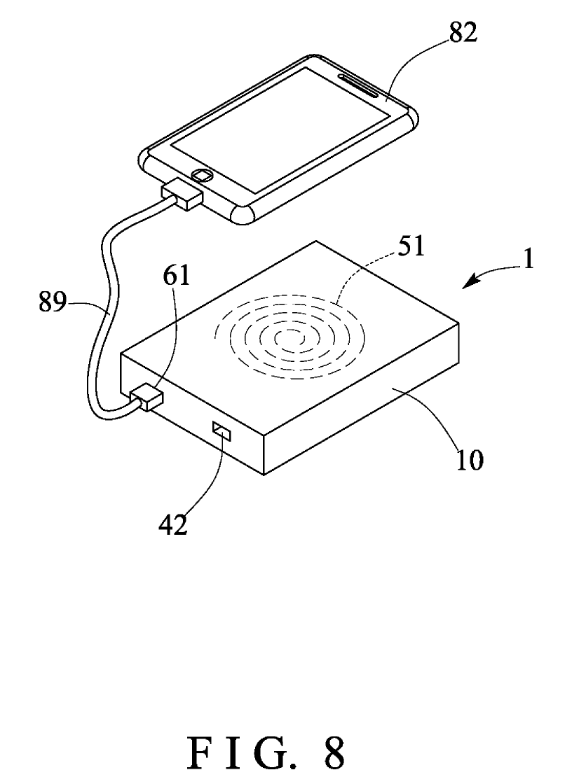

A second charging module 60 is also disposed and received or engaged in the receptacle 10 and electrically connected or coupled to the control module 20, such as connected to the voltage output regulating module 21 of the control module 20, and a second electric connection port or terminal or coupler 61, such as a universal serial bus (USB) is electrically connected or coupled to the second charging module 60 and also electrically connected or coupled to the control module 20, such as connected to the data telecommunicating module 22 of the control module 20, for data or information transmitting or telecommunicating wirelessly or remotely to and from the portable electrical appliances, such as notebooks 80 (FIG. 1), tablets 81 (FIG. 2), mobile phones or portable phones 82 (FIG. 3), etc.; and/or electrically connected or coupled to the portable electrical appliances 80-82 with an electrical wire or cable 89 (FIG. 8).

In operation, as shown in FIG. 5, the first coupler 42 may be electrically connected or coupled to various electric power suppliers or reservoirs (not illustrated) from house families, vehicles or the like, in order to charge the battery module 40 directly or indirectly through the first charging module 41, the capacity detecting module 23 may sense or detect the electrical capacity in the battery module 40 which may then be shown or displayed in the displayer 43, and the displayer 43 may be selected from liquid crystal displaying units, liquid emitting diodes (LED), or the like. After being charged, the receptacle 10 of the multi media data storing and transmitting apparatus 1 may be used and operated as a power bank, and may be used and operated either indoors or outdoors, and may be easily carried with the user.

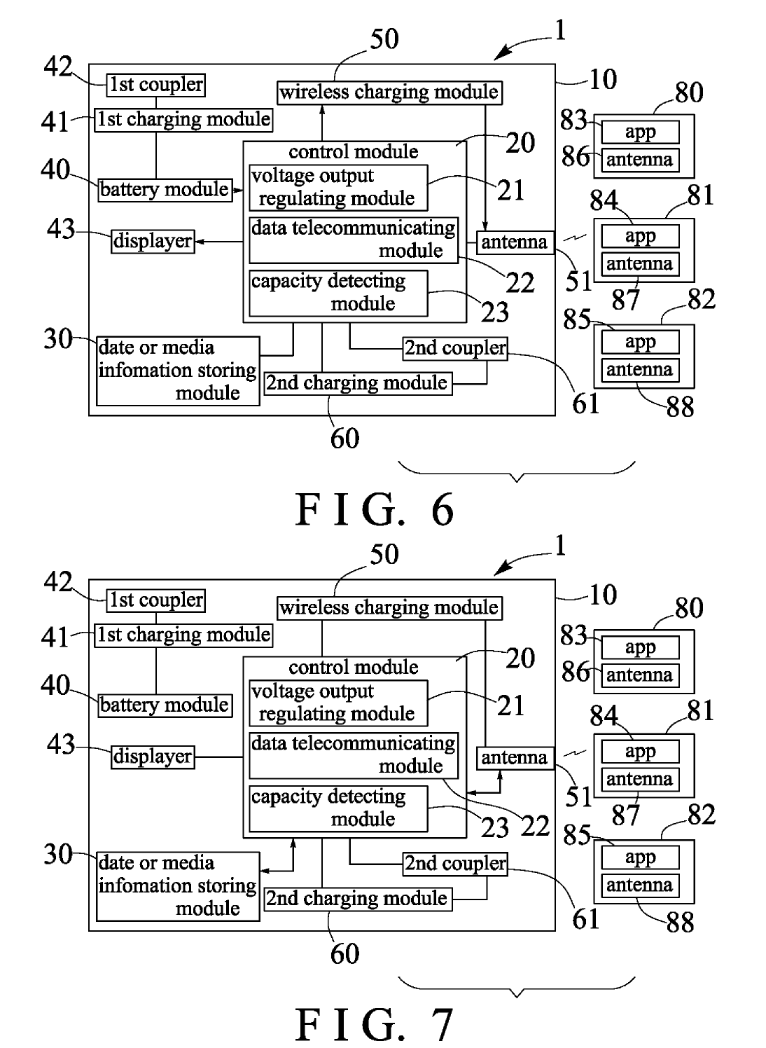

As shown in FIGS. 1-3 and 6, the electrical appliances 80-82 each include an interface, such as a mobile application (APP) 83, 84, 85 disposed and received or engaged therein, and each include an antenna member 86, 87, 88 disposed and received or engaged therein for telecommunicating with the control module 20 with or via the antenna device 51. When either of the electrical appliances 80-82 is required to be charged, the wireless charging module 50 may be actuated or operated by the control module 20, such as actuated or operated by the voltage output regulating module 21 of the control module 20, for wireless telecommunicating with either of the electrical appliances 80-82 with the antenna device 51 and the antenna member 86, 87, 88 and/or the mobile application (APP) 83, 84, 85, in order to charge either of the electrical appliances 80-82 wirelessly or remotely. The electrical capacity in the battery module 40 and/or in the electrical appliances 80-82 may be shown or displayed in the displayer 43.

As shown in FIGS. 1-3 and 7, when or after either of the electrical appliances 80-82 has been charged, the information storing module 30 and/or the data telecommunicating module 22 of the control module 20 may be telecommunicating with either of the electrical appliances 80-82 with the antenna device 51 and the antenna member 86, 87, 88 and/or the mobile application (APP) 83, 84, 85, for data or information, such as electrical documents, word data, images, videos or the like, transmitting or telecommunicating wirelessly or remotely between the control module 20 and the portable electrical appliances 80-82.

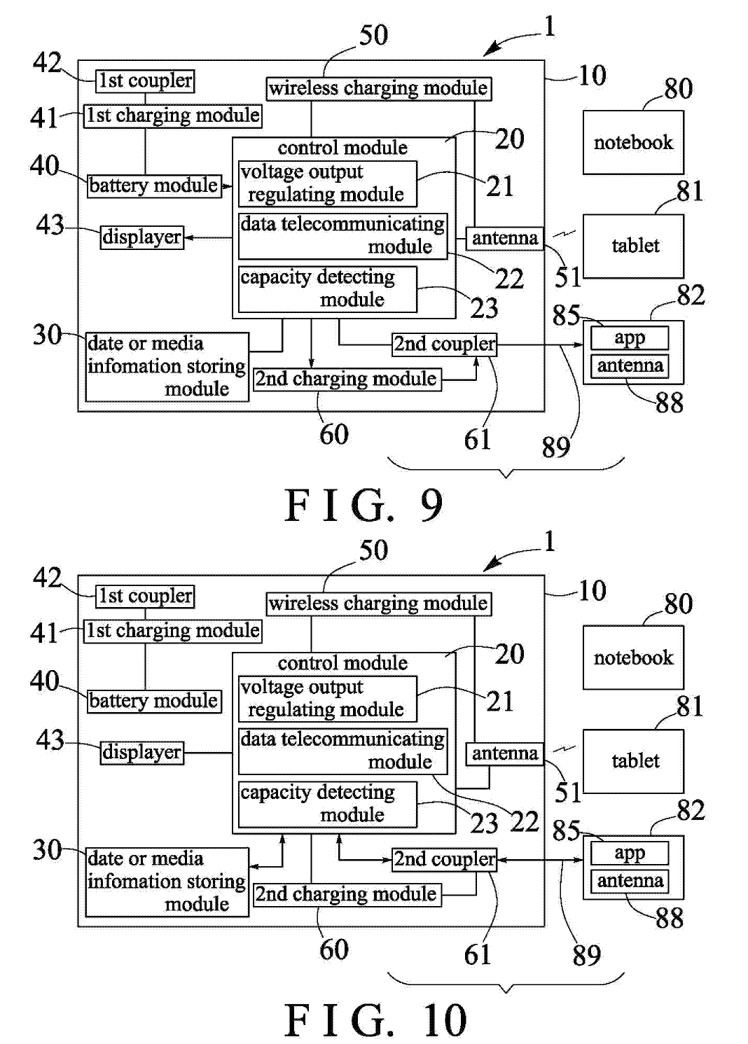

As shown in FIGS. 8 and 9, either of the electrical appliances 80-82 may also be charged with or by the control module 20 with the voltage output regulating module 21 of the control module 20, and/or the battery module 40, the second charging module 60 and the second electric coupler 61 and/or the mobile application (APP) 83, 84, 85, in order to charge either of the electrical appliances 80-82 with the electrical cable 89. The electrical capacity in the battery module 40 and/or in the electrical appliances 80-82 may also be shown or displayed in the displayer 43.

As shown in FIGS. 8 and 10, when or after either of the electrical appliances 80-82 has been charged, the information storing module 30 and/or the data telecommunicating module 22 of the control module 20 may also be telecommunicating with either of the electrical appliances 80-82 with the second charging module 60 and the second electric coupler 61 and/or the mobile application (APP) 83, 84, 85 and the electrical cable 89, for data or information, such as electrical documents, word data, images, videos or the like, transmitting or telecommunicating between the control module 20 and the portable electrical appliances 80-82.

Accordingly, the multi media data storing and transmitting apparatus in accordance with the present invention may be provided for telecommunicating with various electrical appliances, such as portable electrical appliances including notebooks, tablets, mobile phones, portable phones, etc., and for charging the electrical appliances wirelessly or remotely.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A multi media data storing and transmitting apparatus comprising:
an electrical appliance,
a receptacle, and
a control module engaged in said receptacle, said control module including a voltage output regulating module and a data telecommunicating module,
an information storing module engaged in said receptacle and electrically connected to said data telecommunicating module of said control module,
a battery module engaged in said receptacle and electrically connected to said control module,
a first charging module engaged in said receptacle and electrically connected to said battery module,
a first electric coupler electrically connected to said first charging module,
a wireless charging module engaged in said receptacle and electrically connected to said control module, and
an antenna element electrically connected to said wireless charging module and electrically connected to said data telecommunicating module of said control module for telecommunicating with said electrical appliance.

2. The multi media data storing and transmitting apparatus as claimed in claim 1, wherein said information storing module is selected from a compact disc.

3. The multi media data storing and transmitting apparatus as claimed in claim 1, wherein a second charging module is engaged in said receptacle and electrically connected to said voltage output regulating module of said control module, and a second electric coupler is electrically connected to said second charging module and electrically connected to said data telecommunicating module of said control module for telecommunicating with said electrical appliance.

4. The multi media data storing and transmitting apparatus as claimed in claim 1, wherein said control module includes a capacity detecting module electrically connected to said battery module.

5. The multi media data storing and transmitting apparatus as claimed in claim 1, wherein a displayer is electrically connected to said control module for displaying an information.
